(19) United States
(12) Patent Application Publication
(10) Pub. No.: US 2010/0131214 A1
(43) Pub. Date: May 27, 2010

(54) Method and Apparatus for Measuring Transmission and Reception in Electronic Devices

(76) Inventors: Dan Seely, Spokane Valley, WA (US); Thomas Antles, II, Liberty Lake, WA (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 12/324,669

(22) Filed: Nov. 26, 2008

(51) Int. Cl. G06F 19/00

(52) U.S. Cl. 702/58

(57) ABSTRACT

In a representative embodiment, an apparatus comprises a host subsystem comprising a user interface and configured to receive a plurality of parameters; and a processor comprising a hardware interface and configured calculate hardware states based on at least a subset of the plurality of parameters. The apparatus also comprises a first subsystem comprising a hardware control processor adapted to configure first hardware based on the calculated hardware states; and a second subsystem comprising second hardware and a second hardware control processor adapted to configure the second hardware based on the calculated hardware states. The apparatus also comprises a data converter configured to provide data directly to the host subsystem.

### BACKGROUND

Measurements of the function of many electronic devices are made at various times during the lifetime of the device. These measurements include making measurements to ensure quality performance measures are met, or to ensure compliance with institutional standards, or both. As electronic devices become more complex, the litany of measurements performed is increasing. Moreover, manufacturing efficiency is hampered by the comparatively slow known methods of conducting measurements on devices. Thus, manufacturing throughput can be adversely impacted by the time necessary for complicated measurements to be made.

Illustratively, measurements must be made of each wireless handset, base-station or similar device prior to sale. As should be appreciated, these devices are becoming more and more complex with added functionality. Moreover, because manufacturers provide devices adapted for use according to multiple communications protocols, the functionality of each device must be measured across each dedicated frequency band and over specified power ranges, and for the transmission and reception requirements thereof.

Known methods and apparatuses suffer shortcomings that generally impact the speed of the measurements. For example, many known methods and apparatuses for taking measurements of wireless handsets and base stations test a single frequency and a single amplitude or power level at a time. Given the large number of tests required, the conducting of measurements on each device before sale is both labor and time intensive. Moreover, each time a change is made to effect a different measurement, the hardware of the device under test (DUT) must be allowed to settle. Because taking measurements does not begin until the settling is completed, the duration of the measurement is further delayed. Finally, with each new measurement, the apparatus hardware must be set to function according to new parameters. This further adds to the time of each measurement.

Adding more processing power to the test apparatus was the primary method for speeding up measurements. Unfortunately, because hardware state changes and settling for the devices have become the dominant time factor in measurements, increasing processing speed has little or no impact on the overall duration of testing.

What is needed, therefore, is a method and apparatus that overcomes at least the drawbacks of known testing methods and apparatuses described above.

### SUMMARY

In accordance with a representative embodiment, a method comprises: providing a plurality of parameters to an apparatus; configuring hardware based on a subset of the plurality of parameters; running a first measurement at a first frequency and a first power level during a first measurement step; running a second measurement at the first frequency and a second power level during a second measurement step; and during the second measurement, obtaining data from the first measurement step, and computing a plurality of measurement results based from the data.

In accordance with another representative embodiment, an apparatus comprises a host subsystem comprising a user interface and configured to receive a plurality of parameters; and a processor comprising a hardware interface and configured calculate hardware states based on at least a subset of the plurality of parameters. The apparatus also comprises a first subsystem comprising a hardware control processor adapted to configure first hardware based on the calculated hardware states; and a second subsystem comprising second hardware and a second hardware control processor adapted to configure the second hardware based on the calculated hardware states. The apparatus also comprises a data converter configured to provide data directly to the host subsystem.

In accordance with another representative embodiment, a system comprises a system interface and an apparatus connected to the system interface. a data converter configured to provide data directly to the host subsystem. The apparatus comprises a host subsystem comprising a user interface and configured to receive a plurality of parameters; a processor comprising a hardware interface and configured calculate hardware states based on at least a subset of the plurality of parameters; a first subsystem comprising a hardware control processor adapted to configure first hardware based on the calculated hardware states; and a second subsystem comprising second hardware and a second hardware control processor adapted to configure the second hardware based on the calculated hardware states.

### BRIEF DESCRIPTION OF THE DRAWINGS

The present teachings are best understood from the following detailed description when read with the accompanying drawing figures. The features are not necessarily drawn to scale. Wherever practical, like reference numerals refer to like features.

FIG. 1 shows a simplified block diagram of a system in accordance with a representative embodiment.

FIG. 2 is a simplified block diagram of an apparatus in accordance with a representative embodiment.

FIG. 3 shows measurement frames for different frequency and power levels for both an uplink and a downlink test of a device in accordance with a representative embodiment.

FIG. 4 shows a flow-chart of a method in accordance with a representative embodiment.

### DEFINED TERMINOLOGY

As used herein, the terms ‘a’ or ‘an’, as used herein are defined as one or more than one.

In addition to their ordinary meanings, the terms ‘substantial’ or ‘substantially’ mean to with acceptable limits or degree to one having ordinary skill in the art. For example, ‘substantially cancelled’ means that one skilled in the art would consider the cancellation to be acceptable.

In addition to their ordinary meanings, the terms ‘approximately’ mean to within an acceptable limit or amount to one having ordinary skill in the art. For example, ‘approximately the same’ means that one of ordinary skill in the art would consider the items being compared to be the same.

In addition to its ordinary meaning, the term ‘measurement’ comprises measurements, or tests, or calibrations, or a combination thereof. Similarly, in addition to its ordinary meaning, the term ‘measuring’ comprises measuring, or testing, or calibrating, or a combination thereof.

### DETAILED DESCRIPTION

In the following detailed description, for purposes of explanation and not limitation, illustrative embodiments disclosing specific details are set forth in order to provide a thorough understanding of the present teachings. Moreover, descriptions of well-known devices, hardware, software, firmware, methods and systems may be omitted so as to avoid obscuring the description of the illustrative embodiments. Nonetheless, such hardware, software, firmware, devices, methods and systems that are within the purview of one of ordinary skill in the art may be used in accordance with the illustrative embodiments. Finally, wherever practical, like reference numerals refer to like features.

The detailed description which follows presents methods that may be embodied by routines and symbolic representations of operations of data bits within a computer readable medium, associated processors, microprocessors, digital storage oscilloscopes, general purpose personal computers, manufacturing equipment, configured with data acquisition cards and the like. In general, a method herein is conceived to be a sequence of steps or actions leading to a desired result, and as such, encompasses such terms of art as “routine,” “program,” “objects,” “functions,” “subroutines,” and “procedures.”

The apparatuses and methods of the illustrative embodiments are described in implementations in a measurement system including one or more testing devices (e.g., signal sources, spectrum analyzers, and ‘one-box-testers’ (OBTs)). Machines that may perform the test functions according to the present teachings include those manufactured by companies such as AGILENT TECHNOLOGIES, INC., and TEKTRONIX, INC. as well as other manufacturers of test and measurement equipment.

The methods and apparatuses are presented in representative embodiments that involve the taking measurements from, various types of DUTs, including but not limited to user equipment (UE) for many applications. Illustrative DUTs include radio frequency (RF) handsets, chipsets, base-stations and receiver/transmitter hardware thereof. For instance, many embodiments relate to taking measurements of mobile handsets. However, the apparatuses, methods, and systems of the present teachings are more broadly applicable. For illustrative purposes, it is contemplated that the present teachings are applicable to taking measurements of equipment that requires a plurality of measurement steps be performed over a comparatively large range of device settings. Notably, the methods, apparatuses, and systems of the present teachings are contemplated for use in measurements done during manufacture and assembly of electronic devices (e.g., UE); and post-manufacture measurement of the electronic devices.

With respect to the software useful in the embodiments described herein, those of ordinary skill in the art will recognize that there exist a variety of platforms and languages for creating software for performing the procedures outlined herein. Certain illustrative embodiments can be implemented using any of a number of varieties of operating systems (OS) and programming languages. For example, the OS may be a commercially available OS from Microsoft Corporation, Seattle, Wash., USA, or a Linux OS. The programming language may be a C-programming language, such as C++, or Java.

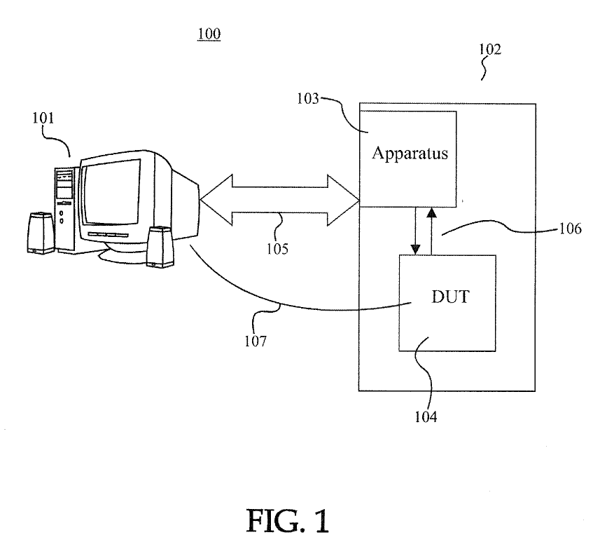

FIG. 1 shows a simplified block diagram of a system 100 in accordance with a representative embodiment. The system 100 comprises a system interface 101 and a measurement instrument 102. The measurement instrument 102 comprises an apparatus 103 and is configured for placement of a device under test (DUT) 104. Notably, the DUT is not a component of the test instrument 102, but rather is located in or connected to the test instrument 102 during device testing. In certain representative embodiments, the DUT 104 may be connected by wireless connections to the measurement instrument 102, or by wired connections to the test instrument 102, or both.

The system interface 101 is connected to the apparatus test instrument via interconnection 105, which may be an electrical or optical connection, to include wired, wireless and fiber connections. Generally, the system interface 101 is a stand-alone computer (e.g., a personal computer), but may be a component of a computer system/network, or may be a handheld device comprising requisite hardware, software and an interface allowing the input of user-based parameters and the gathering of information from the test instrument 102. Still alternatively, the system interface may be a component of the apparatus 103 and not a stand-alone or separate device. Moreover, and as described more fully below, a link 107 between the system interface 101 and the DUT 104 may be included. The link 107 is illustratively a wireless link and may be used, for example to provide a trigger to the DUT 104 to commence an operation. For example, if the DUT 104 were a piece of wireless UE (e.g., a mobile phone), the link 107 may provide a trigger to begin transmitting so that a measurement may begin. Still other uses of a direct link such as 107 are contemplated and many will be within the purview of the artisan of ordinary skill having had the benefit of the present disclosure.

The apparatus 103 comprises hardware, software and, optionally, firmware useful in setting up measurements and testing of the DUT 104; and the gathering of data from the measurements and tests. Details of the components and the functionality of the apparatus 103 are provided below in connection with the description of representative embodiments.

The DUT 104 illustratively comprises a wireless device, such as a wireless handset, a wireless base station or a repeater. For instance, and without limitation, wireless devices contemplated as DUT 104 include wireless and cellular phones, personal digital assistants (PDAs), personal computers, global positioning system devices and communications radios. Additionally, chip sets for use in wireless devices are also contemplated as the DUT 104. In addition, components of wireless base stations and repeaters are also contemplated for the DUT 104.

The DUT 104 may be connected to the measurement instrument 102 via a dedicated connector (not shown) and may be docked to the instrument 102. Alternatively, the instrument may comprise interconnections (also not shown) useful in effecting the communications and power connections between the instrument 102 and the DUT 104. Connections to the instrument are believed to be within the purview of one of ordinary skill in the art and are not described more fully in order to avoid obscuring the description of the representative embodiments.

During operation, and as described more fully herein, a user will load a plurality of parameters useful in carrying out a test of the DUT 104 at the system interface 101. The plurality of parameters comprises a desired set of operations to be implemented by the measurement instrument 102. In representative embodiments, these operations comprise measurements of the DUT 104. For example, the measurements may comprise a set of measurements steps established by the manufacturer of the DUT 104 that must be completed prior to its being shipped. Alternatively, the measurements may comprise certain measurements used to trouble-shoot a problem in the DUT 104, for example upon return by an owner.

The plurality of parameters are provided to the instrument 102 via the interconnect 105, and are loaded into respective memory devices with the apparatus 103. The parameters are used to test the DUT through connections 106 between the apparatus 103 and the DUT 104. Test results are then garnered by the apparatus 103 and provided to the user via the system interface 101. Notably, and as described in greater detail below, many sequences and processes used in measurements of the DUT 104 are effected independently and simultaneously. Beneficially, the independent and simultaneous nature of many measurements provides for improved speed and thus overall efficiency improvement.

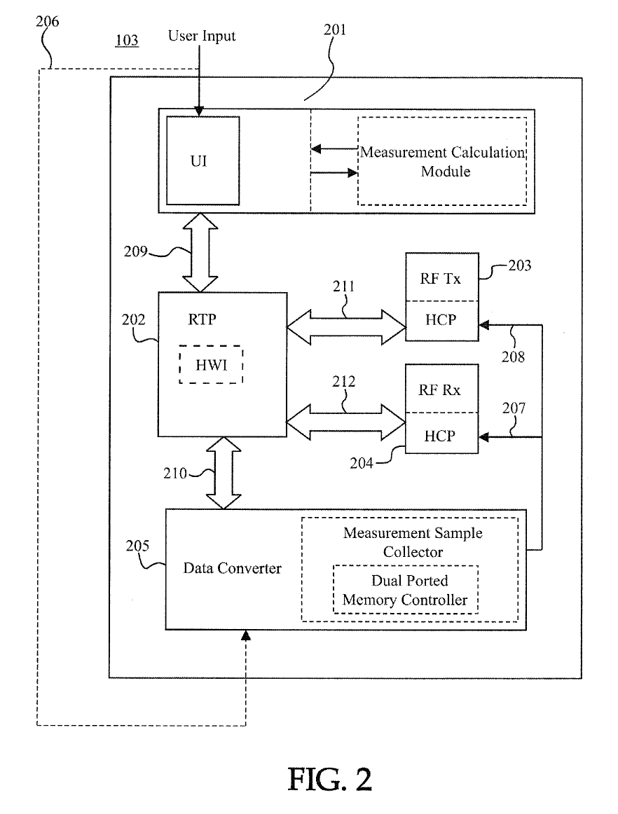

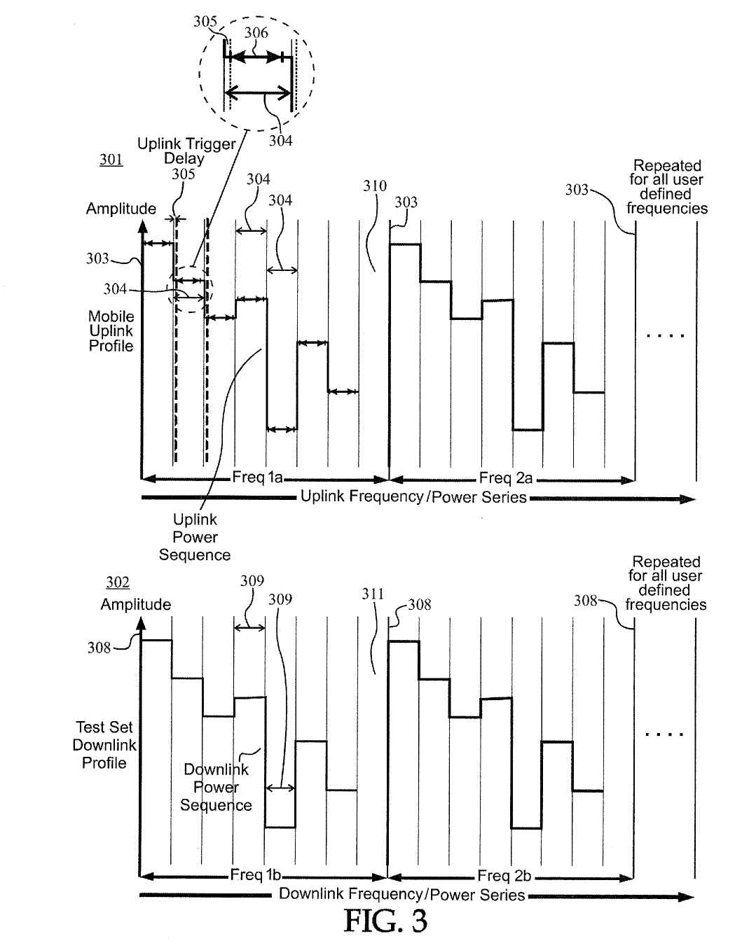

In accordance with certain representative embodiments, during a period of time referred to as a measurement frame, the measurements, or calibration sequences, or both, are carried out at a prescribed frequency. Each measurement frame comprises a plurality of measurement steps. As described more fully herein in connection with embodiments in FIGS. 2 and 3, each measurement step commences with a measurement delay during which no measurements are taken; and a measurement interval during which measurements are taken. During each measurement interval of a measurement step, user-specified measurements are made over a specified period of time and at the prescribed frequency and power level. Beneficially, and in ways and by means described more fully herein, the apparatus 103 is configured to improve efficiencies within the system 100 through substantially simultaneous configuration, measurement and data processing as specified by the user.

FIG. 2 shows a simplified schematic block diagram of apparatus 103 in accordance with a representative embodiment. The apparatus 103 comprises a host subsystem 201, which comprises a user interface (UI) and a measurement calculation module (MCALC). The apparatus 103 also comprises a processor 202, which is illustratively a real time processor (RTP), which is connected to the host subsystem by interconnect 209. In a representative embodiment, the processor 202 is configured to calculate hardware states and set the hardware states useful in effecting measurements of DUTs 104, for example. In a representative embodiment, the RTP comprises a hardware interface module (HWI) useful in calculating and setting hardware states for DUTs, as described more fully herein. The HWI may be instantiated in software in the processor 202, for example.

A first subsystem 203 and a second subsystem 204 are also provided in the apparatus 103, each comprising a hardware control processor (HCP). In representative embodiments, the first subsystem 203 comprises a source (e.g., Tx) subsystem and the second subsystem comprises a receive (e.g., Rx) subsystem configured for testing devices over radio frequencies (RF); and thus is useful in testing of wireless handset, base stations and chip sets, for example. As described more fully herein, the hardware of the first subsystem 203 and the hardware of the second subsystem 204 are configured by respective HCPs to carry out a measurement of a DUT during a particular measurement step based on a user input. While a current measurement step is being carried out, the HWI calculates the hardware states for a subsequent measurement steps. The RTP 202 then provides the configurations for these hardware states to first and second subsystems 203, 204 via interconnects 211 and 212, respectively. In this way, when the present measurement step is completed, the hardware of the subsystems 203, 204 can be readily configured for the next measurements to be taken in one or more subsequent measurement steps. Following the present example, in embodiments where the first subsystem 203 comprises an RF-receive subsystem and the second subsystem comprises an RF-Transmit, the user input may result in the configuration of hardware states by the HCP of the RF source and the HCP of the RF receive subsystem to carry out a measurement during a prescribed measurement step at a set frequency and power level.

The apparatus 103 also comprises a data converter 205, which is connected to the RTP 202 via an interconnect 210, and may be instantiated in hardware, software, firmware or combinations thereof. The data converter 205 comprises a measurement sample collector and a dual ported memory controller. As described more fully herein, the data converter 205 provides: triggers useful in test and measurement timing and signal generation timing for calibration; data storage from tests and measurements; and direct memory access (DMA) to memory in the host processor 201. In certain embodiments efficiencies are attained by providing a programmable logic device (PLD) such as a field programmable gate array (FPGA) to implement the functionality of the data converter 205. Most notably, the inclusion of the PLD fosters the DMA function directly to the host subsystem 201.

Certain functionality of each component of the apparatus 103 is provided via representative embodiments described in connection with applications to measurement and testing of mobile communications devices. It is emphasized that the presently described embodiments are merely illustrative and that other applications beyond mobile communications are contemplated. In general, the present teachings are contemplated for use in many applications where multiple measurements requiring dynamic changes in hardware settings are used. As should be appreciated, these applications include but are not limited to a variety of electronic devices including, but not limited to computers, GPS devices and entertainment devices (e.g., televisions), to name only a few.

In a representative embodiment, the host subsystem 201 comprises a processor instantiated in hardware and software. Illustratively, the host subsystem 201 comprises high speed commercially processor such as a Dual-core Pentium® by Intel® or similar processor and the measurement calculation module (MCALC) comprises a comparatively high-speed built-in floating-point math co-processor. The UI receives a user input, which comprises measurement set-up data, measurement initiation data, triggers and results queries. As should be appreciated by one skilled in the art, the measurement set-up data and measurement initiation data are specific to each application. For example, and as alluded to above, in order to complete a measurement sequence from a particular manufacturer, or in order to ensure compliance with an accepted standard, the user may provide measurement set-up data and initiation data to effect the measurement sequence or compliance of the device with the applicable standard. In a representative embodiment where measurements are conducted on a wireless handset configured to function according to one or more wireless protocols (e.g., CDMA, GSM, WCDMA), the measurement set up and initiation data may comprise and thereby specify: a Mobile Uplink Profile; a Mobile Uplink Frequency Re-tune Step; a Measurement Step; an Uplink Trigger Delay; a Step Length; a Measurement Interval; an Uplink Power Sequence; an Uplink Frequency/Power Series; a Test Set Downlink Profile; a Downlink Frequency Re-tune Step; a Mobile Rx Step; a Downlink Power Sequence; and a Downlink Frequency/Power Series. Moreover, the measurement set up and initiation data specifies a plurality of measurements to be completed during specified measurement steps. Collectively, these plurality of parameters comprise a DUT profile; a step list, which comprises the succession of steps for various power levels at a selected frequency and the measurements performed in dedicated steps (commonly referred to herein as measurement steps); and the timing of each step.

As alluded to above, these measurement set up and initiation data are merely illustrative. It is emphasized that more or fewer data are contemplated, as are data required for different applications than mobile communications. Some of the listed data are within the purview of one of ordinary skill in the art and details thereof are omitted to avoid obscuring the description of the representative embodiments. Additionally, some of these noted data are described more fully below.

The MCALC provides post processing based on data garnered during a test. The MCALC receives measurement data from the data converter 205, illustratively in the form of individual data packets to process from each measurement step. As alluded to previously, these data are provided via DMA to the host processor 201, thereby expediting data transfer and calculations by circumventing the operating system. Moreover, the MCALC is configured to perform calculations on data from previous measurement steps, during a current measurements step, and while calculations are made for hardware states of subsequent measurement steps. The calculations performed on data from measurements provide measurement results. In representative embodiments in which measurements are conducted on a wireless handset configured to function according to one or more wireless protocols (e.g., CDMA, GSM, WCDMA). The measurement results computer on data from a measurement step may comprise, for example: Mean Power, Root Raised Cosine (RRC) Filtered Mean Power, Spectrum Monitor, Adjacent Channel Leakage Ratio (ACLR), Spectrum Emissions Mask (SEM), Occupied Bandwidth (OBW), Error Vector Magnitude (EVM), Peak EVM, Chip EVM, Magnitude Error, Phase Error, IQ Gain and Phase Imbalance, Origin Offset, Frequency Error, Peak Code Domain Error (PCDE), Code Domain Error, Beta Levels, IQ Constellation, IQ Samples.

Ultimately, the interconnects and concurrent processing and calculating improves the overall efficiency of the apparatus 102 to effect measurements, to return the data therefrom, and to provide measurement results based on the calculations. As described above, and among other functions, the RTP 202 computes the hardware states of the various components of the first and second subsystems 203 and 204 needed to effect the measurements and sequences desired by a user.

In representative embodiments where the first and second subsystems 203, 204 comprise a source and receive subsystem, respectively, frequency and power levels of operation of the subsystems 203, 204 are set for certain prescribed measurements based on user input to the apparatus 103. In a representative embodiment, the computing of the hardware states by the RTP 202 comprises computing operating values for hardware required for each frequency and power level. Notably, the frequency and power levels may be prescribed by a standard or protocol, prescribed by a user to attain certain specifications (e.g., quality specifications), or mandated by a communications agency (e.g., the U.S. Federal Communications Commission (FCC), as should be appreciated by one of ordinary skill in the art.

The hardware state changes occur at certain times and for prescribed time durations (e.g., measurement steps as described below). As should be appreciated by one of ordinary skill in the art having had the benefit of the present disclosure, the hardware state changes are specific to the circuits of first and second subsystems 203, 204. For example, in certain embodiments, the first subsystem 203 comprises a RF-Tx subsystem comprising hardware used to transmit signals to a receiver of the DUT 104; and the second subsystem 204 comprises an RF-Rx subsystem comprising hardware used to receive signals from a transmitter of the DUT 104. The hardware states required to effect measurements of transmissions from and reception by the transmitter and receiver of the DUT 104 depend, among other things, the specific signals sent and received by the first and second subsystems 203, 204, respectively, and the measurements being exacted. For instance, if the measurements related to CDMA communications and for a particular measurement selected by a user, a particular hardware configuration is selected. In the representative embodiments where the first and second subsystems, 203, 204, comprise an RF-TX subsystem and an RF-RX subsystem, respectively, the hardware state changes may require changes in attenuators, phase locked loops (PLLs) and filters, for example in the first and second subsystems 203 and 204, respectively. Hardware state changes for other types of subsystems are governed, of course, by the type of subsystem.

Hardware state changes are calculated for first hardware (e.g., source or Tx hardware) of the first subsystem 203 and for second hardware (e.g., receive or Rx hardware) of the second subsystem 204 at the RTP 202. The hardware states are calculated for a succession of steps in the step list provided by the user via the UI of the host subsystem 201. For example, in a representative embodiment, based on the prescribed measurement sequence, the HWI computes the hardware states for a succession of measurements steps that each require, among other settings, respective frequency and power level for a particular measurement. In a representative embodiment, the HWI is instantiated in software to provide in real time the required hardware states of the various components of the apparatus required for the prescribed tests and measurements. In an illustrative embodiment, the HWI performs these hardware state calculations for a succession of measurement steps and stores these in memory within the RTP 202. The respective calculated hardware states for first and second hardware are then provided to the first subsystem 203 and the second subsystem 204, respectively, as expired hardware states for completed measurement steps are discarded. Thus, the RTP 202 contains an instance of code that comprises the HWI. The HWI is not only responsible for calculating hardware states based on desired user setting, but also for informing the first subsystem 203 and the second subsystem 204 of the calculated hardware states. Moreover, and as described more fully herein, the RTP 202 via the HWI configures, reconfigures and sets the data collection portion of the Data Converter 205, according to user input, for each and every step measurement.

Notably, during the initialization and between new measurement frames, the hardware of the first subsystem 203 and the second subsystem 204 undergo ‘settling.’ During these settling periods, for example, the RTP computes the next hardware states for a succession of measurements steps that each subsystem 203, 204 requires. During measurement in the computed measurement steps, the RTP continues to calculate hardware configurations for later steps and load these configurations into respective memories of the first and second subsystems 203, 204. As such, when one measurement step is completed, the hardware states for the next measurement step are loaded into the first and second subsystems 203, 204. Beneficially, by effecting hardware state configurations while measurements or calibrations, or both, are being carried out, subsequent measurement steps are commenced without significant delay. As should be appreciated by one of ordinary skill in the art, this improves measurement speed and efficiency by avoiding delays. Moreover, the time required to begin a measurement sequence (e.g., over a number of measurement frames) may also be reduced because rather than requiring all required hardware configurations for the measurement sequence or calibration sequence to be loaded before a beginning, according to a representative embodiment, the calculations and for hardware states for only a few measurements steps are needed to begin measurement sequences or calibration sequences.

Furthermore, and as will become clearer as the present description continues, the measurement size and duration is substantially without bound because number of measurement steps or measurement frames does not impose any additional burden on the RTP 202 to contain or calculate those steps or frames in advance. Rather, and as described more fully herein, the hardware states for each measurement step are calculated, and after the measurement step is terminated, the stored states are discarded.

The first subsystem 203 receives hardware state settings from the RTP 202. Continuing with the illustrative embodiment in which the DUT 104 comprises a mobile handset, base station or chip set, the first subsystem 203 comprises a source subsystem and the first hardware comprises source hardware of the source subsystem. The hardware state settings are provided in a memory (not shown), such as a HOP RAM, provided in the HCP of the first subsystem 203. The memory stores a plurality of hardware states for successive measurement steps of a step list and provides these sequentially to the source hardware of the source subsystem for each measurement step. In a representative embodiment, memory triggers (e.g., HOP RAM triggers) are provided from the data converter 205 to the first subsystem 203. These triggers foster synchronous indexing to a next successive hardware state for a next successive measurement step. Beneficially, and as described previously, the memory discards a hardware state that has expired upon indexing to the next hardware state/measurement step in the step list.

Similarly, the second subsystem 204 receives hardware state settings from the RTP 202. Continuing with the illustrative embodiment in which the DUT comprises a mobile handset, base station or chip set, the second subsystem 204 comprises a receiver subsystem and the second hardware comprises receiver hardware of the receiver subsystem. The hardware state settings are provided in a memory (not shown) such as a HOP RAM provided in the HCP of the second subsystem 204. The memory stores a plurality of hardware states for successive measurement steps of a step list and provides these sequentially to the receiver hardware of the receiver subsystem 204 for each measurement step. In a representative embodiment, memory triggers (e.g., HOP RAM triggers) are provided from the data converter 205 to the second subsystem 204. These triggers effect indexing to a next successive hardware state for a next successive measurement step. Beneficially, the memory discards a hardware state that has expired upon indexing to the next hardware state/measurement step in the step list.

The data converter 205 comprises a measurement sample collector, and collects and stores data in the measurement sample collector from various measurements of the DUT and converts the data from analog to digital data. The data converter 205 may be instantiated in hardware, software, firmware or a combination thereof. Illustratively, in addition to other hardware, the data converter 205 comprises an FPGA that comprises software in cores instantiated to effect certain functions. However, this is merely illustrative and other devices are contemplated. For example, other types of PLDs may be used. Moreover, solutions solely based on software are contemplated.

In a representative embodiment in which the DUT is a mobile handset, base station or chip set, these analog data may be a set of intermediate frequency (IF) data that are converted by the data converter 205 to a digital data, such as by known analog-to-digital converters ADCs. These data are then provided to measurement sample collector and then to the host processor via DMA fostering comparatively fast data recovery and post-processing.

As alluded to previously, the measurement sample collector comprises a PLD configured for DMA to the host processor 201. In a representative embodiment, the PLD comprises an FPGA configured with DMA to provide data to the host processor 201. In a representative embodiment, the data may be substantially uncorrected data, at least partially corrected data, or corrected data.

The measurement sample collector of the data converter 205 also comprises a dual ported memory controller that allows data to be stored while simultaneous retrieval of a previously collected set of data is retrieved. These data may be stored in partitioned memory that is provided in the measurement sample collector, for example. Notably, once data from a measurement are provided to the host processor 201, these data are removed from the measurement sample collector so that data from subsequent measurements can be provided to the measurement sample collector. Beneficially, this allows for a substantially unimpeded gathering and transfer of data by the data converter 205 and to the host subsystem 201.

Another significant function of the data converter 205 relates to triggering of the sequence of measurements (e.g., during a measurement frame). The measurement sample collector receives an initiation trigger specified by the user input. There are a variety of ways measurements can be triggered. For example, the initiation trigger may be a user trigger 206, for example, and may be provided directly to the data converter 205. Alternatively, or additionally immediate triggers may be used to commence a measurement at the user interface; and there may be triggers due to detection of an RF signal rise or fall that does not come directly from the user input to the data converter 205, but rather is detected by one or both of the first and second subsystems 203, 204, or the data converter, or a combination thereof. In turn, these triggers to the first and second subsystems 203, 204, or data converter can trigger the data converter 205 to begin. Thus, the initiation trigger may come from directly from the user (e.g., as does user trigger 206), but does not necessarily come directly from the user to the data converter 205. Whatever the path, the initiation trigger sets the initiation of measuring and, in combination with the plurality of parameters provided by the user input, forms the baseline for the timing of many subsequent triggers in a measurement.

In a representative embodiment, the measurement sample collector comprises a real-time step counter that is synchronized to the initiation trigger (e.g., user trigger 206). Once this counter is so synchronized, many subsequent triggers, including the HOP RAM triggers for each measurement frame, each measurement step, and each measurement delay, can be set based on the plurality of parameters provided by the user input. The generation and synchronization of these triggers are provided by the data converter 205 and provided to the first and second subsystems 203, 204.

As alluded to previously, the RTP 202 via the HWI, effects the configuration, reconfiguration and setting of the data collection portion of the Data Converter 205, according to user input, for each measurement step. Based on triggers received from the data converter 205 over an interconnect 210, the RTP 202 configures the Data Converter 205 for the next data collection (e.g., at the end of a measurement step). In addition, in response to these triggers from the Data Converter 205, the RTP 202 updates expired hardware states by removing expired hardware states for completed measurement steps and writing the new hardware configurations to respective memory (e.g., HOP RAMs) (not shown) of the subsystems 203, 204 after the completion of a measurement step. The sequencing by the RTP 202 to add new hardware states to a memory (e.g., HOP RAMs) in order to replace expired hardware steps (e.g., after the completion of a measurement step) from the memory of the first and second subsystems 203, 204 are based on triggers initially configured in the Data Converter 205 by the RTP 202 via HWI based on user settings.

The sequencing to change to a new hardware state by first subsystem 203 and second subsystem 204 may be effected by HOP RAM triggers 207, 208 provided from the data converter 205 to the first and second subsystems 203, 204, respectively. In a representative embodiment, the HOP RAM triggers 207, 208, which also are based on a clock signal initiated by user input, may be a rising edge triggers that cause the first and second subsystems 203, 204 to transition to the next state hardware state for a particular measurement step.

As shown in FIG. 2, interconnects 209-212 are provided between components of the apparatus 103. In representative embodiments, these interconnects provide comparatively large data transfer capabilities to ensure comparatively fast data transfer. In certain embodiments, the interconnects 209-212 comprises personal component interconnect express (PCI Express or PCIe) bus known to one of ordinary skill in the art. The PCIe bus comprises one or more ‘lanes’ for two-way data transfer between the host subsystem 201 and the RTP 202; between the RTP 202 and the subsystems 203, 204; and between the RTP 201 and the data converter 205.

Among other benefits, the ability to transfer data comparatively quickly fosters simultaneous measurements, data recovery and processing. For example, and as described above, while measurement are made in particular measurement steps using subsystems 203, 204, data gathered from a previous measurement step can be provided from the data converter 205 to the host processor 201. Calculations can then be made using these data to provide measurement results. Concurrent with these calculations' being made at the MCALC of the host processor 201, current measurements may be made by the first and second subsystems 203, 204, and also concurrently, the HWI of the RTP 202 may calculate hardware states for future measurement. These hardware states can then be quickly loaded via interconnects 211, 212 to respective subsystems 203, 204. Moreover, and while measurements are made in a current measurement step, hardware states are calculated, and calculations using data from previous measurements, the host processor 101 can provide additional subsets of the plurality of parameters to the RTP 202 via interconnect 209. These parameters can be then used to calculate subsequent hardware states for the subsystems 203, 204 for particular measurements to be made, for example.

FIG. 3 shows measurement frames for different frequency and power levels for both an uplink and a downlink measurement of a device in accordance with a representative embodiment. The description of the measurement steps refers to aspects of conducting measurements described in conjunction with the representative embodiments described in conjunctions with FIGS. 1 and 2. In general, the details of these aspects of conducting measurements are not repeated to avoid obscuring the description of the presently described embodiment(s). Notably, the embodiments described in conjunction with FIG. 3 relate to an uplink measurement and a downlink measurement of a mobile handset. For example, the handset may be a cellular phone or PDA configured to function according to multiple wireless protocols (e.g., WCDMA and GSM), requiring multiple frequency bands and power levels of operation. Again, and as emphasized above, the application to wireless communications is illustrative, and other applications are contemplated.

A mobile uplink profile 301 and a downlink mobile profile 302 each comprise a plurality of measurements based on user inputs. Uplink profile 301 comprises a series of measurement frames, which commence at measurement frame breaks 303. Each measurement frame comprises measurements conducted at a substantially constant frequency (e.g., freq 1a, freq 1b, etc.). The measurement frames each comprise a plurality of measurement steps 304. Each measurement step 304 comprises a measurement interval 306 and a trigger delay 305 at the beginning measurement step (see enlarged view of one measurement step). Similarly, the downlink profile 302 comprises measurement frame breaks 308 that each mark the beginning of a new measurement frame. Each measurement frame comprises a plurality of measurement steps 309.

The measurement steps 304, 309 are defined by the user and are input via the plurality of parameters provided at the user input to the apparatus 103. During each step, user defined measurements, which are also provided by the user and are input via the plurality of parameters at the user input to the apparatus 103, are made at a set frequency and power level. Illustratively, the duration of each measurement step is set by the user (again via the plurality of parameters), and can be different from one measurement step to the next. For example, it may be required that a particular measurement at a particular frequency and power level combination be run over a longer duration than another measurement within the same measurement frame. Thus, the user input would select the measurement interval of this particular measurement step to have a longer duration.

During measurement steps 304, 309, the DUT and the TX and RX subsystems transmit and receive at a frequency and power level prescribed for that measurement step by the user. The trigger delays, which are set by the user and provided via the user input to the apparatus 103, are provided at the beginning of the measurement step beneficially protect against false measurements. In particular, during the trigger delay, measurements are not taken to allow the DUT (e.g., the mobile handset) to settle to its new power level. As should be appreciated by one of ordinary skill in the art, allowing the power level to change before any measurements are made substantially avoids erroneous measurements due to transients that can be made when the handset amplitude may be changing. Usefully, the trigger delay 305 is only a small portion of the overall step length. For example, in a representative embodiment, the delay may be approximately 25 μs of a step length of approximately 667 μs. Once the trigger delay is completed, measurements are made during the measurement interval 306.

As described above, while measurements are being made in one measurement step 304, 309, the RTP 202 calculates (via the HWI) and loads the hardware states memory (e.g., HOP RAMs) of the source and receiver subsystems for subsequent measurement steps 304, 309. Moreover, after a measurement step is completed, the RTP 202 deletes the hardware state from the memory. Furthermore, data from a complete measurement step are provided to measurement sample collector and then to the host processor 201 via DMA. These data are then used in calculations by the MCALC module. As should be appreciated by one of ordinary skill in the art, the apparatuses and methods of the representative embodiments allow for measurements to be made, hardware states to be calculated for subsequent measurements, and calculations based on data from previous measurements to be made, all concurrently. Beneficially, comparatively fast hardware implementation, data recovery and post-processing are fostered.

At the end of each measurement frame, frequency re-tune intervals 310, 311 at the uplink profile and the downlink profile, respectively, are provided. Like many other aspects of the profiles, the intervals 310, 311 are user specified via the plurality of parameters provided at the user input to the apparatus 103. The intervals 310, 311 are periods before the measurement frame breaks 303, 308 where no measurements are taken. Rather, during interval 310 the DUT re-tunes to a new frequency; and during interval 311 the transmitter and receiver of the system 100 re-tune to a new transmission and reception frequency, respectively. Illustratively, the intervals 310, 311 are approximately one measurement step in duration.

In a representative embodiment, the uplink and downlink measurement steps are repeated for all frequencies specified by the user, and allow a wide variety of measurements to be conducted by the user over a range of frequency and power combinations. In essence, a user may conduct measurements on a DUT over its dynamic range. Among other advantages accorded by the methods and apparatuses of the representative embodiments are a number of efficiencies due to simultaneous measurements, hardware state calculations, and data processing. For example, the downlink and uplink measurements may be done in parallel. Thus, the apparatus 103 and system 101 will track the mobile handset while it is amplitude and frequency hop over a user-defined profile. While tracking the transmitted signals from the mobile (Uplink) and making measurements on the transmitted signals, the system 100 can also simultaneously transmit a compliant modulated downlink signal over a different pre-defined frequency/amplitude profile which is used to simultaneously make measurements on the receiver of the mobile handset (Ms RX). Thus, the measurements of the uplink and downlink of the mobile handset are in essence substantially independent, and concurrent in time.

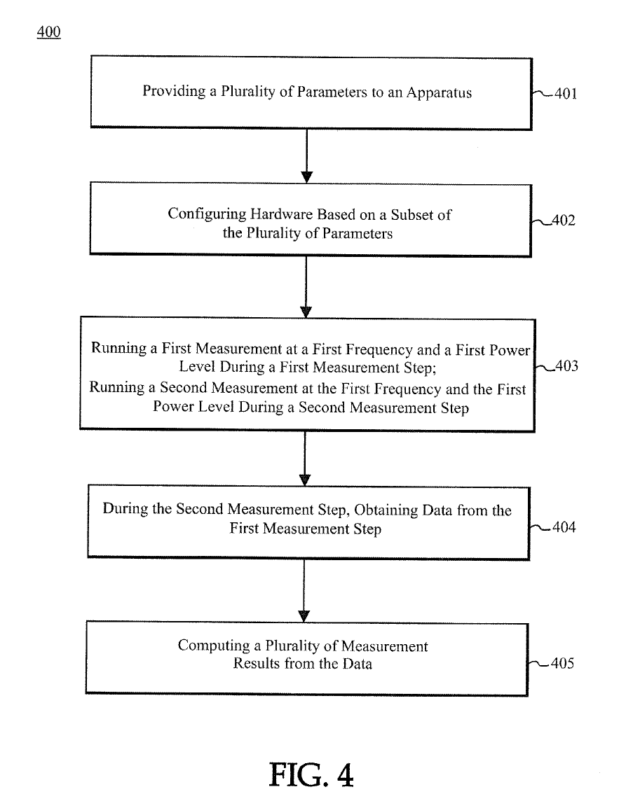

FIG. 4 shows a flow-chart of a method 400 in accordance with a representative embodiment. The description of the measurement steps refers to aspects of measurements described in conjunction with the representative embodiments described in conjunctions with FIGS. 1-3. In general, the details of these aspects of measurements are not repeated to avoid obscuring the description of the presently described embodiment(s).

At 401 the method comprises providing a plurality of parameters to an apparatus. Illustratively, the parameters comprise user defined parameters provided via the system interface 101 and to the apparatus 103 via user input. At 402, the method comprises configuring hardware in a device under test (DUT) based on a subset of the plurality of parameters. As described previously, the hardware configuration comprises changing hardware states for measurements at different frequencies, or power levels, or both. At 403, the method comprises running a first measurement at a first frequency and a first power level during a first measurement step; and running a second measurement at the first frequency and the first power level during a second measurement step. For example, as described previously, during a measurement frame, a frequency is selected, and measurements may be conducted at one or more power levels.

At 404 during the second measurement, the method comprises obtaining data from the first measurement step; and prior to an end of the second measurement step, calculated hardware states of a subsequent measurement step, which are based on another subset of the plurality of parameters, are loaded in the memory (e.g., HOP RAM) of the first subsystem 203, or the second subsystem 204, or both. As described more fully above, these hardware states are For example, and as described previously, the HCP of the first subsystem 203, or the HCP of the second subsystem 204, or both, may effect a change in the hardware states of the their respective subsystem.

At 405, a plurality of measurement results is computed from the data. As described above, the MCALC computes the measurement results from data provided to the host processor 201 directly from the data converter 205.

In view of this disclosure it is noted that the apparatuses, systems and methods useful for measurements of devices, components and systems can be implemented in a variety of components, variant subsystems, configurations and topologies. Moreover, applications other than devices under test may benefit from the present teachings. Further, the various software, hardware, firmware protocols and parameters are included by way of example only and not in any limiting sense. In view of this disclosure, those skilled in the art can implement the present teachings in determining their own applications and needed materials and equipment to implement these applications, while remaining within the scope of the appended claims.

1. A method, comprising:
providing a plurality of parameters to an apparatus;
configuring hardware based on a subset of the plurality of parameters;
conducting a first measurement at a first frequency and a first power level during a first measurement step;
conducting a second measurement at the first frequency and a second power level during a second measurement step; and
during the second measurement, obtaining data from the first measurement step, and computing a plurality of measurement results based on the data.

2. A method as claimed in claim 1, further comprising, after the obtaining, providing the data directly to a host processor.

3. A method as claimed in claim 1, wherein the parameters further comprise hardware state settings.

4. A method as claimed in claim 1, wherein the first and second measurements each comprise a measurement on an uplink of a device under test (DUT), and the method further comprises:
substantially simultaneously with either the first measurement, or the second measurement, or both the first and second measurements, conducting a third measurement at a second frequency and a second power level during a third measurement step, wherein the third measurement comprises a measurement on a downlink of the DUT.

5. A method as claimed in claim 1, wherein the first and second measurement steps occur during a first measurement period and another subset of the plurality of parameters comprises parameters for a second measurement period.

6. A method as claimed in claim 1, after the providing the plurality of parameters, setting a trigger to initiate the first measurement.

7. A method as claimed in claim 2, further comprising, after the obtaining and before the providing, converting the data to digital data; and the providing further comprises:
providing the digital data from a first memory to a second memory by direct memory access (DMA).

8. A method as claimed in claim 1, wherein first measurement step and the second measurement step each comprise respective step lengths and trigger delays and the trigger delays are less than approximately 20% of a duration of the step length.

9. A method as claimed in claim 2, wherein the providing the hardware state settings further comprises:
receiving a plurality of frequencies and power levels; and
calculating operating values for hardware required for each frequency and power level.

10. An apparatus, comprising:
a host subsystem comprising a user interface and configured to receive a plurality of parameters;
a processor comprising a hardware interface and configured calculate hardware states based on at least a subset of the plurality of parameters;
a first subsystem comprising a hardware control processor adapted to configure first hardware based on the calculated hardware states; a second subsystem comprising second hardware and a second hardware control processor adapted to configure the second hardware based on the calculated hardware states; and
a data converter configured to provide data directly to the host subsystem.

11. An apparatus as claimed in claim 10, wherein the data converter further comprises a measurement sample collector.

12. An apparatus as claimed in claim 10, wherein the data converter further comprises a direct memory access (DMA) module configured to transfer the data directly to a memory in the host processor.

13. An apparatus as claimed in claim 10, wherein the first subsystem further comprises a source subsystem and the first hardware comprises source hardware, and the source subsystem further comprises a source memory configured to store a subset of the calculated hardware states and to replace an expired hardware state with a new hardware state from the subset of the plurality hardware states.

14. An apparatus as claimed in claim 10, wherein the second subsystem further comprises a receiver subsystem and the second hardware comprises receiver hardware, and the receiver subsystem comprises a receiver memory configured to store a subset of the calculated hardware states and to replace an expired hardware state with a new hardware state from the subset of the plurality hardware states.

15. An apparatus as claimed in claim 11, wherein the data converter further comprises a dual ported memory controller configured to collect data from a current measurement and to substantially simultaneously transfer data from a previous measurement directly to the host subsystem.

16. An apparatus as claimed in claim 12, wherein the data converter is configured to receive a trigger from a user and to populate a memory with a plurality of measurement triggers based on the received trigger.

17. An apparatus as claimed in claim 11, wherein the data converter is connected to a device under test (DUT).

18. An apparatus as claimed in claim 17, wherein first data are transmitted to the DUT and second data are received from the DUT substantially simultaneously.

19. An apparatus as claimed in claim 18, wherein the DUT comprises a radio frequency (RF) device.

20. A system, comprising:
a system interface;
apparatus connected to the system interface, the apparatus comprising:
a host subsystem comprising a user interface and configured to receive a plurality of parameters;
a processor comprising a hardware interface and configured calculate hardware states based on at least a subset of the plurality of parameters;
a first subsystem comprising a hardware control processor adapted to configure first hardware based on the calculated hardware states; a second subsystem comprising second hardware and a second hardware control processor adapted to configure the second hardware based on the calculated hardware states; and
a data converter configured to provide data directly to the host subsystem.

21. A system as claimed in claim 20, wherein data converter comprises a measurement sample collector configured to provide data directly to the host subsystem.

22. A system as claimed in claim 21, wherein the data converter further comprises a direct memory access (DMA) module configured to transfer the data directly to a memory in the host processor.

23. A system as claimed in claim 20, wherein the first subsystem comprises a source subsystem and the first hardware comprises a receiver hardware, and the source subsystem comprises a source memory configured to store a subset of the calculated hardware states and to replace an expired hardware state with a new hardware state from the subset of the plurality hardware states.

24. A system as claimed in claim 20, wherein the second subsystem comprises a receiver subsystem and the second hardware comprises receiver hardware, wherein the receiver subsystem comprises a receiver memory configured to store a subset of the calculated hardware states and to replace an expired hardware state with a new hardware state from the subset of the plurality hardware states.

25. A system as claimed in claim 21, wherein the data converter further comprises a dual ported memory controller configured to collect data from a current measurement and to substantially simultaneously transfer data from a previous measurement directly to the host subsystem.

26. A system as claimed in claim 22, wherein the data converter is configured to receive a trigger from a user and to populate a memory with a plurality of measurement triggers based on the received trigger.

27. A system as claimed in claim 21, wherein the data converter is connected to a device under test (DUT).

28. A system as claimed in claim 27, wherein first data are transmitted to the DUT and second data are received from the DUT substantially simultaneously.
